(19) United States
(12) Patent Application Publication
(10) Pub. No.: US 2016/0164075 A1
(43) Pub. Date: Jun. 9, 2016

(54) PROCESS FOR PRODUCING AN ACTIVE CATHODE MATERIAL COMPRISING A MIXTURE OF A METAL OXIDE AND A METAL SULFIDE AND USE OF THE ACTIVE CATHODE MATERIAL IN RECHARGEABLE ELECTROCHEMICAL CELLS

(71) Applicant: BASF SE, Ludwigshafen (DE)

(72) Inventors: Arnd GARSUCH, Ludwigshafen (DE); Frederick Francois CHESNEAU, St. Leon-Rot (DE); Sebastien SALLARD, Nussbaumen bei Baden (CH); Petr NOVAK, Brugg AG (CH)

(73) Assignee: BASF SE, Ludwigshafen (DE)

(21) Appl. No.: 14/905,614

(22) PCT Filed: Jul. 4, 2014
(86) PCT No.: PCT/IB2014/062848

§ 371 Date: Jan. 15, 2016

(30) Foreign Application Priority Data
Jul. 15, 2013 (EP) 13176518.2

(51) Int. Cl. H01M 4/36; H01M 4/58; H01M 4/52

(52) U.S. Cl. CPC H01M 4/364; H01M 4/523; H01M 4/5815

(57) ABSTRACT

Provided are a process for producing an active cathode material comprising at least one oxide of a metal M and at least one sulfide of said metal M, an active cathode material obtained by said process, electrodes comprising said active cathode material and rechargeable electrochemical cells comprising said electrodes.

The present invention relates to a process for producing an active cathode material comprising at least one oxide of a metal M and at least one sulfide of said metal M, to an active cathode material obtainable or obtained by the process according to the invention, to electrodes comprising said active cathode material and to rechargeable electrochemical cells comprising said electrodes.

Secondary batteries, accumulators or rechargeable batteries are just some embodiments by which electrical energy can be stored after generation and used when required. Due to the significantly better power density, there has been a move in recent times away from the water-based secondary batteries to development of batteries in which the charge transport in the electrical cell is accomplished by lithium ions.

A crucial component in a secondary lithium battery is the active cathode material. Commercial active cathode materials are usually based on transition metal compounds like the corresponding oxides or phosphates as described in Chem. Rev. 2004, 104, 4271-4301. The capacity of these materials is usually in the range from 140 to 180 mAh/g. Commercial active cathode materials are often based on cobalt oxide. Since the terrestrial abundance of cobalt is lower than most of the other transition metals of the fourth period of the periodic table cobalt is more precious than these. Therefore alternative active cathode materials have been investigated which either are more cost efficient or which show an improved capacity.

U.S. Pat. No. 4,934,922 describes transition metal oxysulfides, like MoOS₂, which are prepared by mixing at least one transition metal oxide and at least one transition metal sulfide in aqueous ammonia, removing the ammonia and then decomposing the residue at elevated temperature under nonoxidizing conditions.

Tchangbedji et al., Journal of Power Sources, 43-44 (1993), 577-581 discloses the synthesis von V₂O₄S by reacting, at room temperature, hydrated sodium sulfide dissolved in water with VOCl₂.

US 2011/0045351 describes the formation of electrodes of batteries. The method includes placing a substrate of a battery in a bath consisting of a metal M chosen from a metal group consisting of Fe, Ni, Co, Cu, W, V, and Mn, an oxidant selected from an oxidant group consisting of oxygen and sulfur, and a polymer. For example FeOₓS_{y} modified cathodes were obtained by electrodeposition from a bath that contained 0.04M FeCl₃, 0.08M sodium citrate and 0.4M of thiosulfate on Ni substrates.

Pinna et al., Angew. Chem. Int. Ed. 2008, 47, 5292-5304 discloses surfactant-free non-aqueous sol-gel routes for the synthesis of nanocrystalline metal oxides with high compositional homogeneity and purity.

Ludi et al., Chem. Commun., 2011, 47, 5280-5282 discloses a synthetic route to crystalline ZnS and SnS₂ particles by using benzyl mercaptan as solvent.

Proceeding from this prior art, the object was to find a flexible and more efficient synthesis route to active cathode materials and to find active cathode materials, which are improved with regard to at least one of the following properties: capacity, cycle life, economic feasibility, resistance to chemicals, electrochemical corrosion resistance, mechanical stability and temperature stability. In addition, optimization of the costs caused by material and production expenditure should be taken into account, in order to promote the proliferation of this new energy storage technology.

This object is achieved by a process for producing an active cathode material comprising at least one oxide of a metal M and at least one sulfide of said metal M, comprising the process steps of
(a) preparation of a mixture comprising
   (A) at least one liquid organic phase comprising
      (A1) at least one organic compound comprising oxygen, and
      (A2) at least one organic compound comprising sulfur,
   and
   (B) at least one source of metal M which is at least partly soluble in the liquid organic phase (A),
(b) thermal treatment of the mixture formed in process step (a) in a temperature range from 20° C. to 300° C.,
   and
(c) optionally isolation of the active cathode material, which is formed in process step (b).

The metal M of the active cathode material prepared by the inventive process can be varied in a wide range. Preferably metal M is a transition metal, more preferably a transition metal of the fourth period of the periodic table, even more preferably Cr, Mn, Co, Ni or Fe, in particular Fe.

In one embodiment of the present invention, the inventive process is characterized in that the metal M is Cr, Mn, Co, Ni or Fe, in particular Fe.

Preferred oxides of metal M are Cr₂O₃, CrO₂, Mn₃O₄, Mn₂O₃, MnO₂, CoO, Co₃O₄, NiO or Fe₃O₄, Fe₂O₃, in particular Fe₃O₄.

Preferred sulfides of metal M are CrS, Cr₂S₃, MnS, CoS, Co₂S₃, NiS, Ni₂S₃, FeS, Fe₃S₄ or Fe₂S₃, in particular Fe₃S₄.

The mixture prepared in process step (a) of the inventive process comprises as a first component at least one liquid organic phase (A), also referred to hereinafter as phase (A) for short, which comprises at least one organic compound comprising oxygen (A1), also referred to hereinafter as compound (A1) for short, and at least one organic compound comprising sulfur (A2), also referred to hereinafter as compound (A2) for short, and as a second component at least one source of metal M (B), also referred to hereinafter as metal source (B) for short, which is at least soluble in the liquid organic phase (A).

Phase (A) is preferably liquid in a temperature range from 0° C. to 400° C., more preferable in a temperature range from 20° C. to 300° C. In addition to compound (A1) and compound (A2) phase (A) might also comprise at least one inert organic solvent that does not react with metal source (B) but has the ability to dissolve compound (A1), compound (A2) and metal source (B). Such an

Examples of inert organic solvents are acetonitrile, dichloromethane, formamides, in particular N,N-dimethylformamide, sulfoxides, in particular dimethylsulfoxide, substituted or unsubstituted diphenylethers, in particular brominated diphenylethers, glycols, in particular ethylene glycol or poly(ethylene glycol) with an average M_{w} from 100 to 400 g/mol or polyvinyl alcohol with an average M_{w} from 500 to 200 000 g/mol.

Preferably compound (A1) and compound (A2) form a mixture that is liquid at 20° C. without the addition of an inert organic solvent.

In a likewise preferred embodiment, the sum of the proportions by weight of all compounds (A1) and all compounds (A2) is from 50 to 100%, preferably 80 to 100%, especially 90 to 100%, based on the total weight of sum of the liquid organic phases (A) of the mixture prepared in process step a).

Compound (A1) comprises a functional group comprising oxygen, that is able to react with a source of metal M (B) and forms an oxide of said metal (B). Preferably compound (A1) comprises at least one hydroxyl group that is able to react with a source of metal M (B) under formation of a corresponding metal oxide. Preferably the at least one hydroxyl group is bound to a secondary, tertiary or α-unsaturated carbon atom, in particular to an α-unsaturated carbon atom.

Preferred compounds (A1) are selected from the group of compounds consisting of unsubstituted arylmethanol, substituted arylmethanols and mixtures thereof, preferably selected from the group of compounds consisting of unsubstituted phenylmethanol, substituted phenylmethanols, preferably substituted with one or more radicals selected from the group consisting of C₁-C₆-alkyl, C₁-C₆-alkoxy, C₂-C₈-dialkyl amino, C₁-C₆-halogenoalkyl and phenyl, and mixtures thereof. Particularly preferred is benzyl alcohol as compound (A1).

In one embodiment of the present invention, the inventive process is characterized in that the organic compound comprising oxygen is selected from the group of compounds consisting of unsubstituted arylmethanol, substituted arylmethanols and mixtures thereof, in particular benzyl alcohol.

Examples of compounds (A1) are benzyl alcohol, (2-naphthyl)methanol, (1-naphthyl)methanol, (9-anthryl)methanol, diphenylmethanol, triphenylmethanol, 1-phenyl ethanol, 1-phenylpropan-1-ol, 1-(2-naphthyl)ethanol, 1-(1-naphthyl)ethanol, 1-(9-anthryl)ethanol, (2-methylphenyl)methanol, (4-methylphenyl)methanol, (2,4-dimethylphenyl)methanol, (2,4,6-trimethylphenyl)methanol, (2-methoxyphenyl)methanol, (3-methoxyphenyl)methanol, (4-methoxyphenyl)methanol, [4-(dimethylamino)phenyl]methanol, bis[4-(dimethylamino)phenyl]methanol, [4-(trifluoromethyl)phenyl]methanol, [3-(trifluoromethyl)phenyl]methanol, [3,5-bis(trifluoromethyl)phenyl]methanol or (10-methyl-9-anthryl)methanol.

Compound (A2) comprises a functional group comprising sulfur, that is able to react with a source of metal M (B) and forms a sulfide of said metal (B). Preferably compound (A2) comprises at least one mercapto group (—SH or sulfhydryl group) that is able to react with a source of metal M (B) under formation of a corresponding metal sulfide. Preferably the at least one mercapto group is bound to a secondary, tertiary or α-unsaturated carbon atom, in particular to an α-unsaturated carbon atom. Preferred compounds (A2) are selected from the group of compounds consisting of unsubstituted arylmethanethiol, substituted arylmethanethiols and mixtures thereof, preferably selected from the group of compounds consisting of unsubstituted phenylmethanethiol, substituted phenylmethanethiols, preferably substituted with one or more radicals selected from the group consisting of C₁-C₆-alkyl, C₁-C₆-alkoxy, C₂-C₈-dialkyl amino, C₁-C₆-halogenoalkyl and phenyl, and mixtures thereof. Particularly preferred is benzyl mercaptane, also called phenylmethanethiol, as compound (A2).

In one embodiment of the present invention, the inventive process is characterized in that the organic compound comprising sulfur is selected from the group of compounds consisting of unsubstituted arylmethanethiol, substituted arylmethanethiols and mixtures thereof.

Examples of compounds (A2) are benzyl mercaptane, (2-naphthyl)methanethiol, (1-naphthyl)-methanethiol, (9-anthryl)methanethiol, diphenylmethanethiol, triphenylmethanethiol, 1-phenyl ethanethiol, 1-phenylpropane-1-thiol, 1-(2-naphthyl)ethanethiol, 1-(1-naphthyl)ethanethiol, 1-(9-anthryl)ethanethiol, (2-methyl phenyl)methanethiol, (4-methylphenyl)methanethiol, (2,4-dimethylphenyl)methanethiol, (2,4,6-trimethylphenyl)methanethiol, (2-methoxyphenyl)methanethiol, (3-methoxyphenyl)methanethiol, (4-methoxyphenyl)methanethiol, [4-(dimethylamino)phenyl]-methanethiol, bis[4-(dimethylamino)phenyl]methanethiol [4-(trifluoromethyl)phenyl]methanethiol, [3-(trifluoromethyl)phenyl]methanethiol, [3,5-bis(trifluoromethyl)phenyl]methanethiol or (10-methyl-9-anthryl)methanethiol

The molar ratio of all compounds (A1) to all compounds (A2) in the liquid organic phase can be varied in a wide range depending on the targeted ratio of metal oxide to metal sulfide and depending on the different reactivities of compounds (A1) and compounds (A2) with respect to the different sources of metal M. Preferably the molar ratio of the sum of compounds (A1) to compounds (A2) is in the range from 100:1 to 1:100, in particular in the range from 20:1 to 1:20.

In one embodiment of the present invention, the inventive process is characterized in that the molar ratio of the organic compound comprising oxygen to the organic compound comprising sulfur is in the range from 100:1 to 1:100, preferably in the range from 20:1 to 1:20.

Metal source (B) is at least partly soluble in phase (A). It is well known that the solubility of a compound increases in most cases when the temperature of the solvent is raised. Preferably metal source (B) is completely soluble in phase (A), preferably at temperature below 40° C.

Metal source (B) can be chosen from a wide range of metal compounds. Appropriate metal sources (B) can be determined by simply testing the solubility of said metal source (B) in phase (A). Preferably the metal source (B) M is selected from the group of compounds consisting of inorganic and organic metal salts, more preferably selected from the group of compounds consisting of metal halogenides, like metal chlorides, metal carbonates, metal acetates and metal acetylacetonates, in particular metal acetylacetonates. A particularly preferred metal source (B) is Fe(acac)₃.

In one embodiment of the present invention, the inventive process is characterized in that the source of metal M is selected from the group of compounds consisting of inorganic and organic metal salts.

Preferred examples of metal source (B) are Cr(acac)₃, Mn(acac)₃, Mn(acac)₂, Co(acac)₃, Co(acac)₂, Ni(acac)₂, Fe(acac)₃, Fe(acac)₂, CrCl₃, CrCl₂, MnCl₂, CoCl₂, NiCl₂, FeCl₃, FeCl₂, Cr(acetate)₂, Mn (acetate)₂, Co(acetate)₂, Ni(acetate)₂ or Fe(acetate)₂.

The mixture prepared in process step (a) is preferably a homogeneous mixture, in particular a solution.

The molar ratio of the sum of all metal sources (B) to the sum of all compounds (A1) and all compounds (A2) in the mixture prepared in process step (a) can be varied in a wide range depending on the targeted ratio of metal oxide to metal sulfide and depending on the reactivities of metal sources (B) with compounds (A1) and compounds (A2). Preferably the molar ratio of the sum of all metal sources (B) to the sum of all compounds (A1) and all compounds (A2) is in the range from 1:1000 to 1:1, in particular in the range from 1:100 to 1:10.

In one embodiment of the present invention, the inventive process is characterized in that the oxide of the metal M is Fe₃O₄, the sulfide of said metal M is Fe₃S₄, the organic compound comprising oxygen is benzyl alcohol, the organic compound comprising sulfur is benzyl mercaptan, the molar ratio of benzyl alcohol to benzyl mercaptan is in the range from 1:20 to 20:1 and the source of metal M is iron(III) acetylacetonate.

In process step b) of the inventive process mixture formed in process step (a) is thermally treated in a temperature range from 20° C. to 300° C., preferably in a temperature range from 100° C. to 200° C. Depending on the boiling point of phase (A) the reaction can be done in an open or a closed system, in vacuum or under pressure. The reaction time can be varied in a wide range depending on the reaction rate.

In the optional process step c) of the inventive process the active cathode material, which is formed in process step (b), is isolated.

Methods for isolation of the active cathode material in the form of a powder are known to those skilled in the art. Possible examples are filtration methods or centrifugation, wherein the isolated material is optionally purified by further process steps, such as washing and drying steps.

The inventive process might comprise additional process steps like a calcination step or a milling step. In an optional process step d) of the inventive process the active cathode material, which is isolated in process step (c), is calcined in a temperature range from 200° C. to 1000° C., preferably in a temperature range from 250° C. to 350° C.

The present invention further also provides an active cathode material comprising at least one oxide of a metal M and at least one sulfide of said metal M, obtainable by a process for producing an active cathode material as described above. This process comprises the above-described process steps (a), (b) and (c), especially also with regard to preferred embodiments thereof.

The present invention likewise also provides an active cathode material comprising at least one oxide of a metal M and at least one sulfide of said metal M, wherein the active cathode material is prepared by a process comprising the process steps of
(a) preparation of a mixture comprising
   (A) at least one liquid organic phase comprising
      (a1) at least one organic compound comprising oxygen, and
      (a2) at least one organic compound comprising sulfur,
   and
      (B) at least one source of metal M which is soluble in the liquid organic phase (A),
(b) thermal treatment of the mixture formed in process step (a) in a temperature range from 20° C. to 300° C., and
(c) optionally isolation of the active cathode material, which is formed in process step (b).

The process steps a), b) and c) have been described above. In particular, preferred embodiments of the process steps have been described above.

The active cathode material, which is obtainable or obtained by the inventive process, comprises least one oxide of a metal M and at least one sulfide of said metal M. Preferred embodiments of the metal M, the oxides and the sulfides of metal M have been described above.

The oxides and sulfides of metal M formed in the inventive process exist in the form of particles, wherein the average particle size preferably is in the range from 1 nm to 100 μm, more preferably in the range from 10 nm to 1 μm, particularly preferred in the range from 20 nm to 100 nm. The average particle size is understood to mean the average particle size of the secondary particles, determined as the volume average. The average particle size can be determined according to Scanning Electron Microscopy (SEM), Transmission Electron Microscopy (TEM) measurement or light scattering measurements.

The oxide of metal M is preferably Fe₃O₄, in particular magnetite, and the sulfide of metal M is preferably Fe₃S₄, in particular greigite.

The ratio between the oxide of metal M and the sulfide of metal M can be varied in a wide range. Preferably the ratio by weight between the oxide of metal M and the sulfide of metal M is in the range from 100 to 1 to 1 to 100, particularly preferably in the range from 10 to 1 to 1 to 10, especially in the range from 2 to 1 to 1 to 2.

In one embodiment of the present invention, the inventive active cathode material is characterized in that the oxide of the metal M is Fe₃O₄, the sulfide of said metal M is Fe₃S₄ and the ratio by weight between the Fe₃O₄ and Fe₃S₄ is in the range from 2 to 1 to 1 to 2.

In a likewise preferred embodiment, the sum of the proportions by weight of the oxide of metal M and the sulfide of metal M is from 50 to 100%, preferably 80 to 100%, especially 90 to 100%, based on the total weight of the inventive active cathode material.

The structure and composition, in particular different crystal phases, of the active cathode material formed in the inventive process can be determined by powder X-ray diffraction.

The inventive active cathode material, which is obtainable or obtained by the above described inventive process, is particularly suitable as a component of an electrode of an electrochemical cell, in particular of a rechargeable electrochemical cell. In addition to the inventive active cathode material an electrode may comprise additional carbon in an electrically conductive polymorph and at least one binder.

The present invention further provides an electrode for a rechargeable electrochemical cell comprising the inventive active cathode material comprising at least one oxide of a metal M and at least one sulfide of said metal M as described above.

The inventive electrode comprises preferably in addition to the inventive active cathode material carbon in an electrically conductive polymorph, also called carbon (C) for short in the context of the present invention and/or at least one binder, also called binder (D) for short in the context of the present invention.

Carbon (C) can be selected, for example, from graphite, carbon black, carbon nanotubes, graphene or mixtures of at least two of the aforementioned substances.

In one embodiment of the present invention, carbon (C) is carbon black. Carbon black may, for example, be selected from lamp black, furnace black, flame black, thermal black, acetylene black and industrial black. Carbon black may comprise impurities, for example hydrocarbons, especially aromatic hydrocarbons, or oxygen-containing compounds or oxygen-containing groups, for example OH groups. In addition, sulfur- or iron-containing impurities are possible in carbon black.

In one variant, carbon (C) is partially oxidized carbon black.

In one embodiment of the present invention, carbon (C) comprises carbon nanotubes. Carbon nanotubes (CNT for short), for example single-wall carbon nanotubes (SW CNTs) and preferably multiwall carbon nanotubes (MW CNTs), are known per se. A process for production thereof and some properties are described, for example, by A. Jess et al. in Chemie Ingenieur Technik 2006, 78, 94-100.

Graphene in the context of the present invention is understood to mean almost ideally or ideally two-dimensional hexagonal carbon crystals which have an analogous structure to individual graphite layers.

In a preferred embodiment of the present invention, carbon (C) is selected from graphite, graphene, activated carbon and especially carbon black.

Carbon (C) may be present, for example, in particles which have a diameter in the range from 0.1 to 100 μm, preferably 2 to 20 μm. The particle diameter is understood to mean the mean diameter of the secondary particles, determined as the volume average.

In one embodiment of the present invention, carbon (C) and especially carbon black has a BET surface area in the range from 20 to 1500 m²/g, measured according to ISO 9277.

In one embodiment of the present invention, at least two, for example two or three, different kinds of carbon (C) are mixed. Different kinds of carbon (C) may differ, for example, with regard to particle diameter or BET surface area or degree of contamination.

In one embodiment of the present invention, the carbon (C) selected is a combination of carbon black and graphite.

In one embodiment of the present invention, the carbon (C) selected is a combination of two different carbon blacks.

The binder (D) is typically an organic polymer. Binder (D) serves principally for mechanical stabilization of the components of the inventive electrode, by virtue of active cathode material particles and optionally carbon (C) particles being bonded to one another by the binder, and also has the effect that the active cathode material has sufficient adhesion to an output conductor. The binder (D) is preferably chemically inert toward the chemicals with which it comes into contact in an electrochemical cell.

In one embodiment of the present invention, binder (D) is selected from organic (co)polymers. Examples of suitable organic (co)polymers may be halogenated or halogen-free. Examples are polyethylene oxide (PEO), cellulose, carboxymethylcellulose, polyvinyl alcohol, polyethylene, polypropylene, polytetrafluoroethylene, polyacrylonitrile-methyl methacrylate copolymers, styrene-butadiene copolymers, tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers, ethylene-chlorofluoroethylene copolymers, ethylene-acrylic acid copolymers, optionally at least partially neutralized with alkali metal salt or ammonia, ethylene-methacrylic acid copolymers, optionally at least partially neutralized with alkali metal salt or ammonia, ethylene-(meth)acrylic ester copolymers, polyimides and polyisobutene.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

The mean molecular weight M_{w} of binder (D) may be selected within wide limits, suitable examples being 20 000 g/mol to 1 000 000 g/mol.

In one embodiment of the present invention, the inventive electrode comprises in the range from 0.1 to 10% by weight of binder (D), preferably 1 to 8% by weight and more preferably 3 to 6% by weight, based on the total mass of active cathode material, carbon (C) and binder (D).

Binder (D) can be combined with active cathode material and carbon (C) by various processes. For example, it is possible to dissolve soluble binders (D) such as polyvinyl alcohol in a suitable solvent or solvent mixture, water/isopropanol for example being suitable for polyvinyl alcohol, and to prepare a suspension with the further constituents of the electrode. After application to a suitable substrate, the solvent or solvent mixture is removed, for example evaporated, to obtain an electrode comprising the inventive active cathode material. A suitable solvent for polyvinylidene fluoride is NMP. The application can be accomplished, for example, by spraying, for example spray application or atomization, and also knifecoating, printing or by pressing. In the context of the present invention, atomization also includes application with the aid of a spray gun, a process frequently also referred to as “airbrush method” or “airbrushing” for short.

If it is desired to use sparingly soluble polymers as the binder (D), for example polytetrafluoroethylene or tetrafluoroethylene-hexafluoropropylene copolymers, a suspension of particles of the binder (D) in question and of the further constituents of the electrode is prepared, and processed as described above to give an electrode.

In one embodiment of the present invention, the electrode in question is the cathode. In the context of the present invention, the electrode referred to as the cathode is that which has reducing action on discharge (operation).

In one embodiment of the present invention, a mixture comprising the inventive active cathode material is processed to give electrodes, for example in the form of continuous belts which are processed by the battery manufacturer.

Electrodes produced from the mixture comprising the inventive active cathode material may, for example, have thicknesses in the range from 20 to 500 μm, preferably 40 to 200 μm. They may, for example, have a rod-shaped configuration, or be configured in the form of round, elliptical or square columns or in cuboidal form, or as flat electrodes.

The electrodes produced with the mixture comprising the inventive active cathode material may have further constituents customary per se, for example an output conductor, which may be configured in the form of a metal wire, metal grid, metal mesh, expanded metal, metal sheet or a metal foil. Suitable metal foils are especially aluminum foils. A flat output conductor, such as an aluminum foil, can be coated on one side or on both sides with the mixture comprising the inventive active cathode material.

The present invention further also provides a rechargeable electrochemical cell comprising at least one inventive electrode comprising inventive active cathode material as described above.

In one embodiment of the present invention, inventive rechargeable electrical cells comprise, as well as inventive electrode comprising inventive active cathode material as described above, at least one electrode comprising metallic magnesium, metallic aluminum, metallic zinc, metallic sodium or preferably metallic lithium.

In a further embodiment of the present invention, above-described inventive rechargeable electrical cells comprise, as well as inventive electrode comprising inventive active cathode material as described above, a liquid electrolyte comprising a lithium-containing conductive salt.

In one embodiment of the present invention, inventive rechargeable electrical cells comprise, in addition to inventive electrode comprising inventive active cathode material as described above and a further electrode, especially an electrode comprising metallic lithium, at least one nonaqueous solvent which may be liquid or solid at room temperature, and is preferably liquid at room temperature, and which is preferably selected from polymers, cyclic and noncyclic ethers, cyclic and noncyclic acetals, cyclic and noncyclic organic carbonates and ionic liquids.

Examples of suitable polymers are especially polyalkylene glycols, preferably poly-C₁-C₄-alkylene glycols and especially polyethylene glycols. These polyethylene glycols may comprise up to 20 mol % of one or more C₁-C₄-alkylene glycols in copolymerized form. The polyalkylene glycols are preferably polyalkylene glycols double-capped by methyl or ethyl.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (X) and (XI)

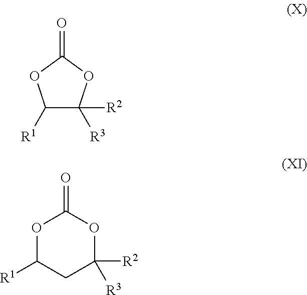

in which R¹, R² and R³ may be the same or different and are selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (XII).

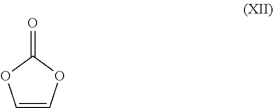

Another preferred cyclic organic carbonate is fluoroethylene carbonate, formula (XIII)

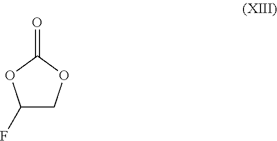

The solvent(s) is (are) preferably used in what is known as the anhydrous state, i.e. with a water content in the range from 1 ppm to 0.1% by weight, determinable, for example, by Karl Fischer titration.

In one embodiment of the present invention, inventive rechargeable electrochemical cells comprise one or more conductive salts, preference being given to lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,
m=2 when X is selected from nitrogen and phosphorus, and
m=3 when X is selected from carbon and silicon.

Preferred conductive salts are selected from LiC(CF₃SO₂)₃, LiN(CF₃SO₂)₂, LiPF₆, LiBF₄, LiClO₄, particular preference being given to LiPF₆ and LiN(CF₃SO₂)₂.

In one embodiment of the present invention, inventive rechargeable electrochemical cells comprise one or more separators by which the electrodes are mechanically separated from one another. Suitable separators are polymer films, especially porous polymer films, which are unreactive toward metallic lithium and toward the electrolyte in the inventive electrochemical cell. Particularly suitable materials for separators are polyolefins, especially porous polyethylene in film form and porous polypropylene in film form.

Separators made from polyolefin, especially made from polyethylene or polypropylene, may have a porosity in the range from 35 to 45%. Suitable pore diameters are, for example, in the range from 30 to 500 nm.

In another embodiment of the present invention, the separators selected may be separators made from PET nonwovens filled with inorganic particles. Such separators may have a porosity in the range from 40 to 55%. Suitable pore diameters are, for example, in the range from 80 to 750 nm.

Additionally suitable is glass fiber-reinforced paper or inorganic nonwovens, such as glass fiber nonwovens or ceramic nonwovens.

Inventive electrochemical cells give a high voltage and are notable for a high energy density and good stability. More particularly, inventive electrochemical cells are notable for an improved cycling stability.

The inventive electrochemical cells can be assembled to metal-ion batteries, preferably rechargeable metal-ion batteries, especially to rechargeable lithium-ion batteries.

Accordingly, the present invention also further provides for the use of inventive electrochemical cells as described above in rechargeable metal-ion batteries, especially rechargeable lithium-ion batteries.

The present invention further provides rechargeable metal-ion batteries, especially rechargeable lithium-ion batteries, comprising at least one inventive rechargeable electrochemical cell as described above. Inventive rechargeable electrochemical cells can be combined with one another in inventive rechargeable metal-ion batteries, especially in rechargeable lithium-ion batteries, for example in series connection or in parallel connection. Series connection is preferred.

Inventive rechargeable electrochemical cells are notable for particularly high capacities, high performances even after repeated charging and greatly retarded cell death. Inventive rechargeable electrochemical cells are very suitable for use in motor vehicles, bicycles operated by electric motor, for example pedelecs, aircraft, ships or stationary energy stores. Such uses form a further part of the subject matter of the present invention.

The present invention further provides for the use of inventive rechargeable electrochemical cells as described above in motor vehicles, bicycles operated by electric motor, aircraft, ships or stationary energy stores.

The use of inventive rechargeable metal-ion batteries, especially rechargeable lithium-ion batteries, in devices gives the advantage of prolonged run time before recharging and a smaller loss of capacity in the course of prolonged run time. If the intention were to achieve an equal run time with electrochemical cells with lower energy density, a higher weight for electrochemical cells would have to be accepted.

The present invention therefore also further provides for the use of inventive rechargeable metal-ion batteries, especially rechargeable lithium-ion batteries, in devices, especially in mobile devices. Examples of mobile devices are vehicles, for example motor vehicles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The present invention further provides a device comprising at least one inventive rechargeable electrochemical cell as described above.

The invention is illustrated by the examples which follow but do not restrict the invention.

Figures in percent are each based on % by weight, unless explicitly stated otherwise.

The existence of the phases of all composites were proved and determined by Scanning Electron Microscopy (Zeiss Ultra 55) and powder X-ray diffraction which is obtained by using Philips X'pert PRO diffractometer with Cu Kα X-ray radiation (1.54 Å). The elemental compositions of the materials were determined by Energy-dispersive X-ray spectroscopy (EDAX Apollo XV).

### I. Preparation of Active Cathode Materials

### I.1 Synthesis of Material-1

2 mmole (0.706 g) of iron(III) acetylacetonate were mixed with 90 mmol of benzyl alcohol (9.733 g) and 10 mmol of benzyl mercaptan (1.242 g) in a 50 mL three-necked-round bottom flask equipped with a condenser and a magnetic stirring bar. The mixture was stirred at room temperature and argon was bubbled through the mixture for 30 min to remove most of the oxygen. Bubbling was stopped but the mixture was kept under an argon atmosphere. The mixture was heated up to 175° C. under stirring. After 40 h the mixture, which became a suspension, was cooled down to room temperature. The suspension was mixed with acetone in a 1:1 volume ratio and centrifuged in order to isolate the solid material. The solid material was washed 3 times with acetone. The wet solid material was dried in a furnace at 60° C. for several hours. When it seemed to be dry it was milled, transferred into a Petri dish and dried again for several hours in a furnace at 60° C. This dried material is called “Material-1”.

### I.1.a Characterization of Material-1

XRD clearly indicated the formation of Magnetite (Fe₃O₄) phase only.

Results of the EDX analysis: % S=n_{S} (n_{S}+n_{O})=5%, % O=95%,

The morphology was analyzed by SEM. Grain-like nano particles of 25-90 nm size were formed.

### I.2 Synthesis of Material-2

2 mmole (0.706 g) of iron(III) acetylacetonate were mixed with 75 mmol of benzyl alcohol (8.11 g) and 25 mmol of benzyl mercaptan (3.1 g) in a 50 mL three-necked-round bottom flask equipped with a condenser and a magnetic stirring bar. All other steps were identical as described in example I.1. The dried material is called “Material-2”.

### I.2.a Characterization of Material-2

XRD clearly indicates the formation of Magnetite (Fe₃O₄) and Greigite (Fe₃S₄) mostly with traces of Fe₂O₃.

Results of the EDX analysis: % S=nS (nS+nO)=47.5%, % O=52.5%.

The morphology was analyzed by SEM. Irregular octagonal-like shaped particles of 100 nm to several micron size were formed.

### I.3 Synthesis of Material-3

2 mmole (0.706 g) of iron(III) acetylacetonate were mixed with 50 mmol of benzyl alcohol (5.41 g) and 50 mmol of benzyl mercaptan (6.21 g) in a 50 mL three-necked-round bottom flask equipped with a condenser and a magnetic stirring bar. All other steps were identical as described in example I.1. The dried material is called “Material-3”.

### I.3.a Characterization of Material-3

XRD clearly indicates the formation of Greigite (Fe₃S₄) only.

Results of the EDX analysis: % S=nS (nS+nO)=82.5%, % O=17.5%.

The morphology was analyzed by SEM. Pellets-like and needle-like shaped particles of 100 to 500 nm long were formed.

### I.4 Synthesis of Comparative Material-c4

2 mmole (0.706 g) of iron(III) acetylacetonate were mixed with 100 mmol of benzyl mercaptan (12.42 g) in a 50 mL three-necked-round bottom flask equipped with a condenser and a magnetic stirring bar. All other steps were identical as described in example I.1. The dried material is called “Material-c4”.

### I.4.a Characterization of Material-c4

XRD clearly indicates the formation of Greigite (Fe₃S₄) only.

Results of the EDX analysis: % S=nS (nS+nO)=75%, % O=25%.

The morphology was analyzed by SEM. Pellet-like and needle-like shaped particles of 100 to 500 nm length were formed.

### II. Electrochemical Testing of Active Cathode Materials

### II.1.a Preparation of an Electrode (E-1) Comprising Material-1

A mixture of Material-1, Super-P carbon (TIMCAL, Switzerland), Kynar Flex 2801 (Arkema, USA) in a 80/10/10 weight ratio was dispersed in N-Methyl pyrrolidinone (Sigma-Aldrich, USA). The dispersion was casted on aluminum foil and dried under vacuum at 80° C. over night. The dried electrode is call E-1.

### II.1.b Preparation of an Electrode (E-2) Comprising Material-2

A mixture of Material-2, Super-P carbon (TIMCAL, Switzerland), Kynar Flex 2801 (Arkema, USA) in a 80/10/10 weight ratio was dispersed in N-Methyl pyrrolidinone (Sigma-Aldrich, USA). The dispersion was casted on aluminum foil and dried under vacuum at 80° C. over night. The dried electrode is call E-2.

### II.1.c Preparation of an Electrode (E-3) Comprising Material-3

A mixture of Material-3, Super-P carbon (TIMCAL, Switzerland), Kynar Flex 2801 (Arkema, USA) in a 80/10/10 weight ratio was dispersed in N-Methyl pyrrolidinone (Sigma-Aldrich, USA). The dispersion was casted on aluminum foil and dried under vacuum at 80° C. over night. The dried electrode is call E-3.

### II.1.d Preparation of a Comparative Electrode (CE-4) Comprising Hand-Mixed Equimolar Mixture of Magnetite and Greigite

2 mmol of magnetite (0.463 g, Aldrich, ref. 637106) and 2 mmol of home-made greigite (Material-c4) (0.592 g) were thoroughly mixed in a mortar. Then 0.4 g of the magnetite/greigite mixture were mixed with 0.1 g of Super-P carbon (TIMCAL, Switzerland) and 0.1 g of Kynar Flex 2801 (Arkema, USA) dispersed in N-methyl pyrrolidinone (Sigma-Aldrich, USA). The dispersion was casted on aluminum foil and dried under vacuum at 80° C. over night.

Results of the EDX analysis: % S=nS (nS+nO)=56.8%, % O=43.2%

### II.2 Assembly and Operation of Electrochemical Test Cells

The design of the used electrochemical cells is presented in the FIG. 1 of the article P. Novak et al., Journal of the Electrochemical Society, 1995, vol. 142, p. 2544-2550. Circular 13 mm diameter electrodes were punched out of the dried cast. Each sample was weighed on a high precision balance (10 μg precision) with circular 13 mm diameter fresh aluminum used as reference. The average sample weight was about 3 mg±0.3. The casted samples were then reheated overnight at 120° C. under vacuum in order to eliminate the remaining NMP and absorbed water. Cells were assembled from these electrodes in an Ar filled glove-box using a 13 mm diameter disk Li metal (from 0.75 mm Li ribbon from Alfa Aesar, Germany) as counter electrode. Glass fiber was used as the separator and was soaked with 0.5 mL ethylene carbonate:dimethyl carbonate (1:1 by weight ratio) 1 M LiPF₆ electrolyte (Ferro, USA). The electrochemical studies were operated galvanostiscally with a constant current density of 34 mA/g of FeSₓO_{y} both for the charge and discharge steps and voltage boundaries between 1 and 3.5 V on an Astrol battery cycler (Astro) Electronics AG, Switzerland).

TABLE 1
Specific charge evolution (discharge
mode) in mAh/g during cycling

| Electrode | 1^{st} cycle | 5^{th} cycle, | 15^{th} cycle |
|---|---|---|---|
| E-1 | 144.5 | 68.5 | 52.2 |
| E-2 | 235.35 | 164.8 | 79 |
| E-3 | 542.9 | 311.9 | 77.8 |
| CE-4 | 370.8 | 160 | 33.9 |

1. A process for producing an active cathode material comprising at least one oxide of a metal M and at least one sulfide of said metal M, comprising
(a) preparing a mixture comprising
(A) at least one liquid organic phase comprising
(A1) at least one organic compound comprising oxygen, and
(A2) at least one organic compound comprising sulfur,
and
(B) at least one source of metal M which is at least partly soluble in the liquid organic phase (A),
(b) thermally-treating the mixture formed in (a) at a temperature ranging from 20° C. to 300° C.,
and, optionally,
(c) isolating the active cathode material, which is formed in (b).

2. The process according to claim 1, wherein the metal M is Cr, Mn, Co, Ni or Fe.

3. The process according to claim 1, wherein the organic compound comprising oxygen is selected from the group of compounds consisting of unsubstituted arylmethanol, substituted arylmethanols and mixtures thereof.

4. The process according to claim 1, wherein the organic compound comprising sulfur is at least one compound selected from the group of compounds consisting of unsubstituted arylmethanethiol, substituted arylmethanethiols and mixtures thereof.

5. The process according to claim 1, wherein the molar ratio of the organic compound comprising oxygen to the organic compound comprising sulfur is in the range from 100:1 to 1:100.

6. The process according to claim 1, wherein the source of metal M is selected from the group of compounds consisting of inorganic and organic metal salts.

7. The process according to claim 1, wherein the oxide of the metal M is Fe₃O₄, the sulfide of said metal M is Fe₃S₄, the organic compound comprising oxygen is benzyl alcohol, the organic compound comprising sulfur is benzyl mercaptan, the molar ratio of benzyl alcohol to benzyl mercaptan is in the range from 1:20 to 20:1 and the source of metal M is iron(III) acetylacetonate.

8. An active cathode material comprising at least one oxide of a metal M and at least one sulfide of said metal M, obtainable by a process according to claim 1.

9. An active cathode material comprising at least one oxide of a metal M and at least one sulfide of said metal M,
wherein the active cathode material is prepared by a process comprising
(a) preparing a mixture comprising
(A) at least one liquid organic phase comprising
(A1) at least one organic compound comprising oxygen, and
(A2) at least one organic compound comprising sulfur,
and
(B) at least one source of metal M which is soluble in the liquid organic phase (A),
(b) thermally-treating the mixture formed in (a) at a temperature ranging from 20° C. to 300° C.,
and,
(c) isolating the active cathode material, which is formed in (b).

10. An electrode for a rechargeable electrochemical cell comprising the active cathode material comprising at least one oxide of a metal M and at least one sulfide of said metal M according to claim 8.

11. A rechargeable electrochemical cell comprising at least one electrode according to claim 10.

12. A rechargeable lithium-ion battery comprising at least one rechargeable electrochemical cell according to claim 11.

13. A motor vehicle, bicycle having an electric motor, aircraft, ship or stationary energy store comprising the rechargeable electrochemical cell according to claim 11.

14. A device comprising at least one rechargeable electrochemical cell according to claim 11.
